(19) United States
(12) Patent Application Publication
(10) Pub. No.: US 2019/0385462 A1
(43) Pub. Date: Dec. 19, 2019

(54) METHOD OF SHIFTING VEHICLE BETWEEN GROUPS WHILE PLATOONING

(71) Applicant: LG Electronics Inc., Seoul (KR)

(72) Inventor: Inhwan KIM, Seoul (KR)

(21) Appl. No.: 16/557,745

(22) Filed: Aug. 30, 2019

(30) Foreign Application Priority Data
Aug. 16, 2019 (KR) 10-2019-0100335

(51) Int. Cl. G08G 1/00; H04W 4/46; G08G 1/01; H04L 29/08

(52) U.S. Cl. CPC G08G 1/22; G08G 1/207; H04L 67/12; G08G 1/0133; G08G 1/0112; H04W 4/46

(57) ABSTRACT

A method of shifting a vehicle between groups is disclosed. The method includes the actions of obtaining, by at least one vehicle of a first group of vehicles that is platooning, driving route information about a second group of vehicles that is platooning. The actions further include determining, by at least one vehicle of the first group of vehicles, whether at least one first vehicle of the first group of vehicles shifts from the first group of vehicles to the second group of vehicles. The actions further include shifting, by at least one vehicle of the first group of vehicles, a first temporary group of vehicles including the at least one first vehicle of the first group of vehicles to the second group of vehicles.

### CROSS-REFERENCE TO RELATED APPLICATION

The present disclosure claims priority to and the benefit of Korean Patent Application No. 10-2019-0100335, filed on Aug. 16, 2019, the disclosure of which is incorporated herein by reference in its entirety.

### FIELD

The disclosure relates to platooning, and more particularly, to a method of shifting a vehicle of a group between a plurality of groups which are platooning over different routes.

### BACKGROUND

Platooning refers to when vehicles drive, with a shorter interval maintained between successive ones by headway control. Successive vehicles form one group. Information about the movement and potential abnormal contexts of the vehicles in the group is exchanged via inter-vehicle communication and is controlled to maintain the intervals between the vehicles in the group.

However, when all of the vehicles are platooning while staying in their initial groups, inefficiency may arise.

### SUMMARY

An object of the disclosure is to provide a vehicle's inter-group shifting method while platooning, which enables a vehicle to shift groups while multiple groups are driving on a road, thereby allowing for more efficient platooning.

In some implementations, a vehicle's inter-group shifting method while platooning may determine whether a vehicle's inter-group shift is more efficient when a vehicle in one group which is platooning meets another group which is platooning and, according to the result, allows the vehicle to shift between the groups at an adequate time, thereby allowing for more efficient platooning.

In some implementations, a vehicle's inter-group shifting method while platooning may form a temporary group of vehicles which are to shift before an inter-group shift occurs and shift the formed temporary group to a location where an inter-group shift is easy, thereby enabling a vehicle's inter-group shift in a more safe and efficient manner.

According to an innovative aspect of the subject matter described in this application, a method for shifting a vehicle between groups includes the actions of obtaining, by at least one vehicle of a first group of vehicles that is platooning, driving route information about a second group of vehicles that is platooning; determining, by at least one vehicle of the first group of vehicles, whether at least one first vehicle of the first group of vehicles shifts from the first group of vehicles to the second group of vehicles; and shifting, by at least one vehicle of the first group of vehicles, a first temporary group of vehicles including the at least one first vehicle of the first group of vehicles to the second group of vehicles.

These and other implementations can each optionally include one or more of the following features. The first group of vehicles includes a first leader vehicle driving at the head of the first group of vehicles and at least one first following vehicles following the first leader vehicle. The second group includes a second leader vehicle driving at the head of the second group and storing driving route information about the second group of vehicles, and at least one second following vehicles following the second leader vehicle. The actions further include storing, by the first leader vehicle, driving route information about the at least one first following vehicles and driving route information about the first group of vehicles. The action of obtaining the driving route information about the second group of vehicles includes obtaining, by the first leader vehicle, the driving route information about the second group of vehicles from the second leader vehicle. The action of determining whether the at least one first vehicle of the first group of vehicles shifts from the first group of vehicles to the second group of vehicles includes comparing, by the first leader vehicle, the driving route information about the at least one first following vehicles with the driving route information about the second group of vehicles; and determining, by the first leader vehicle, that a vehicle, among the at least one first following vehicles, to shift to the second group of vehicles is of the first temporary group of vehicles.

The action of determining that the vehicle to shift to the second group of vehicles is of the first temporary group of vehicles includes notifying, by the first leader vehicle, the first temporary group of vehicles that the vehicle is scheduled to shift. The action of obtaining the driving route about the second group of vehicles includes obtaining, by each of the at least one first following vehicles, the driving route information about the second group of vehicles from the second leader vehicle. The action of determining whether the at least one first vehicle of the first group of vehicles shifts from the first group of vehicles to the second group of vehicles includes comparing, by each of the at least one first following vehicles, the driving route information about the first following vehicle with the driving route information about the second group of vehicles; and notifying, by each of the at least one first following vehicles, the first leader vehicle that a vehicle is scheduled to shift based on comparing the driving route information about the first following vehicle with the driving route information about the second group of vehicles. The first leader vehicle sets the vehicle scheduled to shift to be of the first temporary group of vehicles. The actions further include shifting the first temporary group of vehicles to a tail of the first group of vehicles. The action of shifting the first temporary group of vehicles including the at least one first vehicle of the first group of vehicles to the second group of vehicles includes shifting the first temporary group of vehicles from the first group of vehicles to the second group of vehicles based on a tail of the second group of vehicles meets a head of the first temporary group of vehicles.

The actions of further include obtaining driving route information about a third group of vehicles that is platooning; determining whether at least one other vehicle of the first group of vehicles, except for the first temporary group of vehicles, shifts from the first group of vehicles to the third group of vehicles; and shifting a second temporary group of vehicles including at least one other vehicle of the first group of vehicles from the first group of vehicles to the third group of vehicles. The actions further include determining an order in which the first temporary group of vehicles and the second temporary group shift of vehicles; and allowing (i) a temporary group of vehicles to shift earlier between the first temporary group of vehicles, (ii) the second temporary group of vehicles to shift to a tail of the first group of vehicles, and (iii) another temporary group of vehicles to shift ahead of the temporary group of vehicles. The actions further include determining, by the first leader vehicle, a time of shift of the first temporary group of vehicles based on one or more of a distance between the first group of vehicles and the second group of vehicles, a location of the first group of vehicles, a location of the second group of vehicles, a speed of the first group of vehicles, and a speed of the second group of vehicles. The actions further include obtaining, by the second leader vehicle or the at least one second following vehicles, the driving route information about the first group of vehicles from the first leader vehicle; determining whether at least one of the at least one second following vehicles shifts from the second group of vehicles to the first group of vehicles; and shifting a second temporary group of vehicles including at least one of the at least one second following vehicle from the second group of vehicles to the first group of vehicles.

According to another innovative aspect of the subject matter described in this application, a method for shifting a vehicle between groups includes the actions of obtaining, by a first leader vehicle driving at a head of a first group of vehicles that is platooning, information about a driving route of a second group of vehicles from a second leader vehicle driving at a head of the second group of vehicles that is platooning; comparing, by the first leader vehicle, the information about the driving route of the second group of vehicles with information about a driving route of at least one first following vehicles driving behind the first leader vehicle; determining, by the first leader vehicle, that a following vehicle, among the at least one first following vehicles, to shift to the second group of vehicles is of a first temporary group of vehicles; and transmitting, by the first leader vehicle and to a vehicle included in the first temporary group of vehicles, a message allowing the first temporary group of vehicles to shift from the first group of vehicles to the second group of vehicles.

These and other implementations can each optionally include one or more of the following features. The action of determining that the following vehicle to shift to the second group of vehicles is of a first temporary group of vehicles includes determining that a platooning maintaining time of the following vehicle or a platooning maintaining distance of the following vehicle is longer when shifting to the second group of vehicles than when staying in the first group of vehicles. The actions further include transmitting, by the first leader vehicle to a vehicle included in the first temporary group, a message allowing the first temporary group of vehicles to shift to a tail of the first group of vehicles. The actions further include obtaining, by the first leader vehicle, information about a driving route of a third group of vehicles from a third leader vehicle driving at a head of the third group of vehicles that is platooning; comparing, by the first leader vehicle, the information about the driving route of the third group with information about a driving route of at least one first following vehicles driving behind the first leader vehicle; determining, by the first leader vehicle, that a following vehicle, among the at least one first following vehicles, to shift to the third group of vehicles is of a second temporary group; and transmitting, by the first leader vehicle to a vehicle included in the second temporary group of vehicles, a message allowing the second temporary group of vehicles to shift from the first group of vehicles to the third group of vehicles. The actions further include determining, by the first leader vehicle, an order in which the first temporary group of vehicles and the second temporary group of vehicles shift; and transmitting, by the first leader vehicle and to a vehicle included in the first temporary group of vehicles and a vehicle included in the second temporary group of vehicles, a message allowing (i) a temporary group to shift earlier to the first temporary group, (ii) the second temporary group to shift to the tail of the first group, and (iii) another temporary group to shift ahead of the temporary group.

According to another innovative aspect of the subject matter described in this application, a method for shifting a vehicle between groups includes the actions of obtaining, by a first following vehicle following a first leader vehicle driving at a head of a first group of vehicles that is platooning, information about a driving route of a second group of vehicles from a second leader vehicle driving at a head of the second group of vehicles that is platooning; comparing, by the first following vehicle, the information about the driving route of the second group of vehicles with information about a driving route of the first following vehicle; based on comparing the information about the driving route of the second group of vehicles with information about the driving route of the first following vehicle, determining, by the first following vehicle, whether to shift to the second group of vehicles; transmitting, by the first following vehicle and to the first leader vehicle, a message indicating that the first following vehicle is scheduled to shift to the second group of vehicles; and shifting the first following vehicle from the first group of vehicles to the second group of vehicles.

These and other implementations can each optionally include one or more of the following features. The actions further include relocating the first following vehicle in the first group of vehicles in response to the message received by the first leader vehicle.

### BRIEF DESCRIPTION OF THE DRAWINGS

FIG. 1 is a view schematically illustrating an example road context for a vehicle's inter-group shifting method.

FIG. 2 is a flowchart of an example vehicle inter-group shifting method.

FIG. 3 is an example process for obtaining a driving route of a second group in the vehicle's inter-group shifting method of FIG. 2.

FIG. 4 is an example process for determining whether an inter-group shift is performed in the vehicle's inter-group shifting method of FIG. 2.

FIG. 5 is a flowchart of an example process for preparing for an inter-group shift and an example process for performing an inter-group shift in the vehicle's inter-group shifting method of FIG. 2.

FIGS. 6A, 6B, 6C, 6D, 7A, 7B, 7C, 7D, 8A, 8B, 8C, 8D, and 8E illustrate examples in which a vehicle shifts between groups using a vehicle's inter-group shifting method.

FIG. 9 is a block diagram of an example computing device capable of implementing a vehicle's inter-group shifting method.

### DETAILED DESCRIPTION

It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

Described below is a method of driving groups of vehicles while platooning.

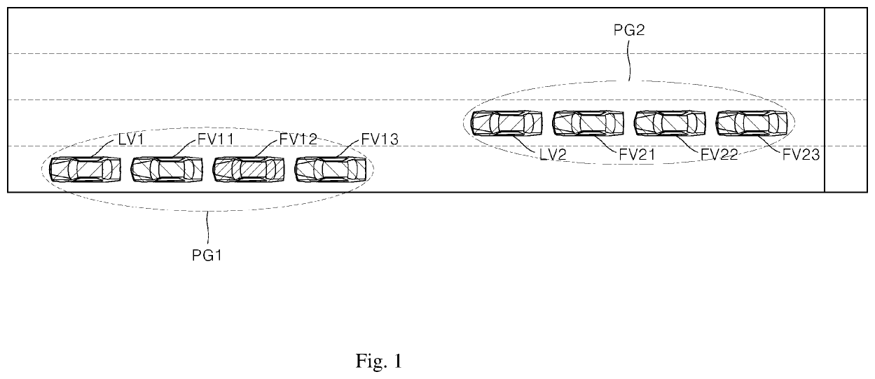

FIG. 1 is a view schematically illustrating an actual road context where a vehicle's inter-group shifting method.

Referring to FIG. 1, a first group PG1 is one group which is platooning. A first leader vehicle LV1 is a vehicle driving at the head of the first group PG1. A first-first following vehicle FV11, a first-second following vehicle FV12, and a first-third following vehicle FV13 of the first group PG1 are vehicles following the first leader vehicle LV1. The first leader vehicle LV1 may grasp and store information about, e.g., a driving route and destination of the first group PG1, and information about a driving route and destination of each of the first-first following vehicle FV11, the first-second following vehicle FV12, and the first-third following vehicle FV13. To that end, the first leader vehicle LV1, the first-first following vehicle FV11, the first-second following vehicle FV12, and the first-third following vehicle FV13 may mutually transmit and receive data in various schemes. For example, the vehicles may transmit and receive data via vehicle-to-everything (V2X) communication or using a 5G network.

A second group PG2 is another group which is platooning. A second leader vehicle LV2 is a vehicle driving at the head of the second group PG2. A second-first following vehicle FV21, a second-second following vehicle FV22, and a second-third following vehicle FV23 of the second group PG2 are vehicles following the second leader vehicle LV2. The second leader vehicle LV2 may grasp and store information about, e.g., a driving route and destination of the second group PG2, and information about a driving route and destination of each of the second-first following vehicle FV21, the second-second following vehicle FV22, and the second-third following vehicle FV23. To that end, the second leader vehicle LV2, the second-first following vehicle FV21, the second-second following vehicle FV12, and the first-third following vehicle FV13 may mutually transmit and receive data in various schemes. For example, the vehicles may transmit and receive data via vehicle-to-everything (V2X) communication or using a 5G network.

The vehicles of the first group PG1 and the vehicles of the second group PG2 may transmit and receive data therebetween in the same method as the vehicles in each group transmit and receive data therebetween.

The vehicles (e.g., the first leader vehicle LV1, the second leader vehicle LV2, the first-first to first-third following vehicles FV11, FV12, and FV13, and the second-first to second-third following vehicles FV21, FV22, and FV23 of FIG. 1) may be associated with any artificial intelligence (AI) modules, drones, unmanned aerial vehicles, robots, augmented reality (AR) modules, virtual reality (VR) modules, and 5th generation (5G) mobile communication devices.

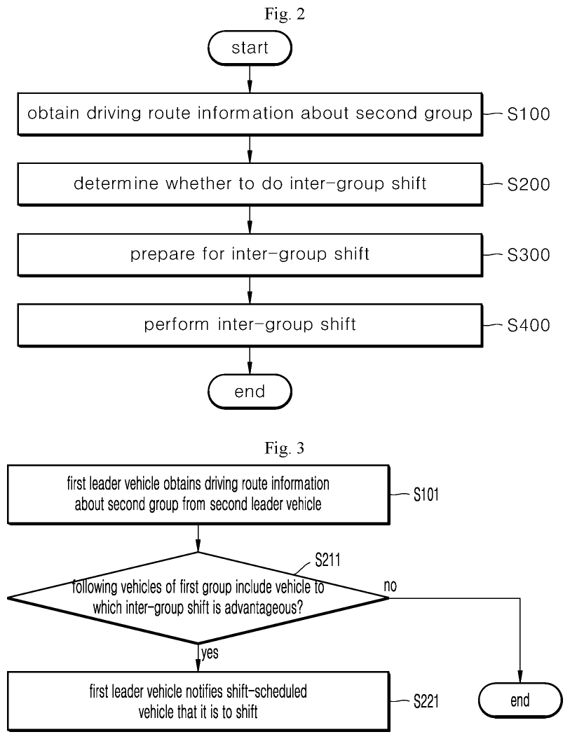

FIG. 2 is a flowchart illustrating a vehicle's inter-group shifting method. Each step of FIG. 2 may be performed by the leader vehicles and/or following vehicles of FIG. 1. To that end, the leader vehicles and/or following vehicles may include at least one or more processors and communication modules.

First, a vehicle (a leader vehicle or a following vehicle) of a first group may obtain information about the driving route of a second group (step S100). For this purpose, the vehicle (a leader vehicle or a following vehicle) of the first group may transmit and receive data to/from a leader vehicle (e.g., the second leader vehicle LV2 of FIG. 1) of the second group.

Next, the vehicle (a leader vehicle or a following vehicle) of the first group may determine whether an inter-group shift occurs (step S200). For example, the vehicle (a leader vehicle or a following vehicle) of the first group may compare when a certain vehicle in the first group drives continuously in the first group with when the vehicle shifts to the second group and drives in the second group and determine whether an inter-group shift occurs according to the result of comparison. Specifically, the vehicle (a leader vehicle or a following vehicle) of the first group may compare the platooning maintaining time or platooning maintaining distance of when the vehicle continues to drive in the first group with the platooning maintaining time or platooning maintaining distance of when the vehicle shifts and drives in the second group and, if the platooning maintaining time and the platooning maintaining distance of when shifting to the second group is longer, determine that shifting to the second group is more advantageous and that the vehicle of the first group shifts to the second group.

Next, an inter-group shift is prepared (step S300). Specifically, the vehicle in the second group may be relocated, or shifted, in the first group. Where there are a plurality of vehicles to shift to the second group, the vehicles to shift to the second group may be relocated in the first group so as to form a temporary group. At this time, the vehicles to shift may be relocated in the first group in response to messages received from the first leader vehicle (e.g., LV1 of FIG. 1). Step S300 may further reduce the likelihood of an accident when an inter-group shift occurs and save time and/or energy consumed for the inter-group shift.

Next, the inter-group shift may be performed (step S400). At this time, the vehicles to shift groups may shift from the first group to the second group in response to messages received form the first leader vehicle (e.g., LV1 of FIG. 1). Or, the inter-group shifting vehicles may determine the time of inter-group shift on their own and, at the time, shift from the first group to the second group. An inter-group shifting method is described below with reference to FIGS. 5 to 8.

In some implementations, as a particular vehicle shifts to a different group while platooning, more efficient platooning may be achieved.

FIG. 3 is a flowchart illustrating the step of obtaining a driving route of a second group and the step of determining whether an inter-group shift occurs in the vehicle's inter-group shifting method of FIG. 2. FIG. 3 illustrates an example in which a vehicle to shift to the second group is determined by the first leader vehicle LV1 of the first group PG1 of FIG. 1.

First, a first leader vehicle (e.g., LV1 of FIG. 1) of a first group (e.g., PG1 of FIG. 1) may obtain driving route information about a second group (e.g., PG2 of FIG. 1) from a second leader vehicle (e.g., LV2 of FIG. 1) of the second group (step S101). The driving route information about the second group may include information about a destination of the second group.

Next, the first leader vehicle (e.g., LV1 of FIG. 1) may determine whether the following vehicles (e.g., FV11, FV12, and FV13 of FIG. 1) of the first group (e.g., PG1 of FIG. 1) include a vehicle to which a shift to the second group (e.g., PG2 of FIG. 1) is advantageous (step S211). In other words, the first leader vehicle may have driving route information about the following vehicles of the first group. (where, the driving route information may include information about the destination.) The first leader vehicle may compare driving route information about each of the following vehicles of the first group with the driving route information about the second group and determine a vehicle to shift among the following vehicles of the first group according to a result of the comparison. A specific method will be apparent from the description taken in conjunction with FIG. 2.

Then, the first leader vehicle (e.g., LV1 of FIG. 1) may notify the vehicle determined to shift among the following vehicles (e.g., FV11, FV12, and FV13 of FIG. 1) of the first group (e.g., PG1 of FIG. 1) that the determined vehicle is scheduled to shift (step S221).

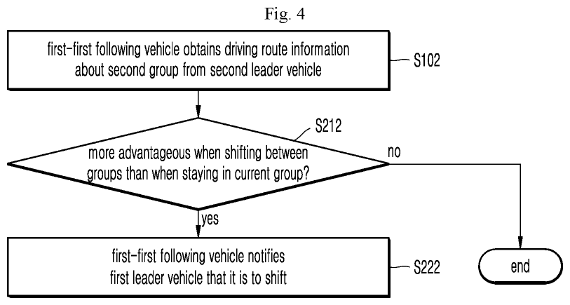

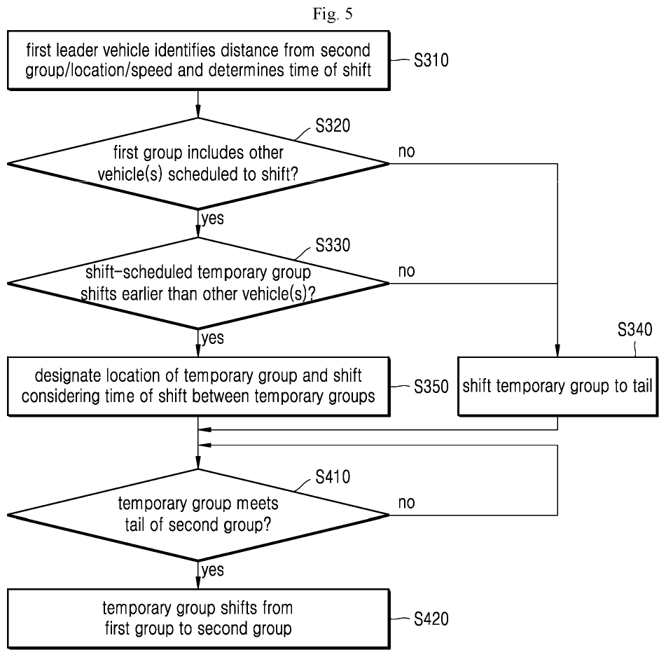

FIG. 4 is a flowchart illustrating the step of obtaining a driving route of a second group and the step of determining whether an inter-group shift occurs in the vehicle's inter-group shifting method of FIG. 2. FIG. 4 illustrates an example in which a vehicle to shift to the second group is determined by any one of the first-first following vehicle to the first-third following vehicle FV11, FV12, and FV13 of the first group PG1 of FIG. 1.

First, any one (e.g., FV11 of FIG. 1) of following vehicles (e.g., FV11, FV12, and FV13 of FIG. 1) of a first group (e.g., PG1 of FIG. 1) may obtain driving route information about a second group (e.g., PG2 of FIG. 1) from a second leader vehicle (e.g., LV2 of FIG. 1) of the second group (step S102). The driving route information about the second group may include information about a destination of the second group.

Next, any one (e.g., FV11 of FIG. 1) of the following vehicles (e.g., FV11, FV12, and FV13 of FIG. 1) of the first group (e.g., PG1 of FIG. 1) may determine which one is more advantageous between when it remains in the first group (e.g., PG1 of FIG. 1) and when it shifts to the second group (e.g., PG2 of FIG. 1) (step S212). For example, the first-first following vehicle may compare its own driving route information with the driving route information about the second group and determine whether a shift to the second group is more advantageous according to the result of comparison. A specific method will be apparent from the description taken in conjunction with FIG. 2.

Then, upon determining that shifting to the second group is more advantageous, any one (e.g., FV11 of FIG. 1) of the following vehicles (e.g., FV11, FV12, and FV13 of FIG. 1) of the first group (e.g., PG1 of FIG. 1) may notify the leader vehicle (e.g., LV1 of FIG. 1) of the first group (e.g., PG1 of FIG. 1) that it is scheduled to shift (step S222). The first leader vehicle may set the vehicles, which have notified the first leader vehicle that they are scheduled to shift, among the following vehicles of the first group in a temporary group which is to shift to the second group.

All of the following vehicles (e.g., FV11, FV12, and FV13 of FIG. 1) of the first group (e.g., PG1 of FIG. 1) may individually perform the steps of FIG. 4.

FIG. 5 is a flowchart illustrating the step of preparing for an inter-group shift and the step of performing an inter-group shift in the vehicle's inter-group shifting method of FIG. 2.

First, a first leader vehicle (e.g., LV1 of FIG. 1) may determine a shifting time by identifying, e.g., a distance to a second group (e.g., PG2 of FIG. 1), the location of the first group (e.g., PG1 of FIG. 1) and the location of the second group, and the speed of the first group and the speed of the second group (step S310). To that end, the first leader vehicle may transmit and receive data to/from the second leader vehicle (e.g., LV2 of FIG. 1) of the second group.

Next, the first leader vehicle (e.g., LV1 of FIG. 1) may determine whether the first group have other vehicles (e.g., a second temporary group) scheduled to shift (step S320).

If there are determined to be other vehicles (e.g., the second temporary group) scheduled to shift in step S320, the first leader vehicle (e.g., LV1 of FIG. 1) may determine whether the first temporary group shifts earlier than the second temporary group (step S330).

If the second temporary group is determined to shift earlier than the first temporary group in step S330, the first leader vehicle (e.g., LV1 of FIG. 1) may designate locations of the temporary groups considering the shifting times between the temporary groups and shift the temporary groups. For example, the first leader vehicle may shift the second temporary group to the tail of the first group (e.g., PG1 of FIG. 1) and then shift the first temporary group ahead of the second temporary group.

Unless there is determined to be other vehicles (e.g., the second temporary group) in step S320 or if the first temporary group is determined to shift earlier than other vehicles scheduled to shift (e.g., the second temporary group) in step S330, the first leader vehicle (e.g., LV1 of FIG. 1) may shift the first temporary group to the tail of the first group.

Next, the first leader vehicle (e.g., LV1 of FIG. 1) may determine whether the head of the first temporary group meets the tail of the second group (e.g., PG2 of FIG. 1) (step S410).

If the head of the first temporary group is determined to meet the tail of the second group (e.g., PG2 of FIG. 1) in step S410, the first leader vehicle (e.g., LV1 of FIG. 1) may shift the first temporary group from the first group (e.g., PG1 of FIG. 1) to the second group (e.g., PG2 of FIG. 1) (step S420).

Unless the head of the first temporary group is determined to meet the tail of the second group (e.g., PG2 of FIG. 1) in step S410, the first leader vehicle (e.g., LV1 of FIG. 1) may wait until the head of the first temporary group meets the tail of the second group (e.g., PG2 of FIG. 1).

Where there are a plurality of groups, all of the respective leader vehicles of the plurality of groups may perform each step of FIG. 5.

Some of the steps of FIGS. 2 to 5 may be omitted as necessary. For example, the step (e.g., S300 of FIG. 2) of preparing for an inter-group shift of FIG. 2 may be excluded. Or, steps S320 to S350 of FIG. 5 may be excluded.

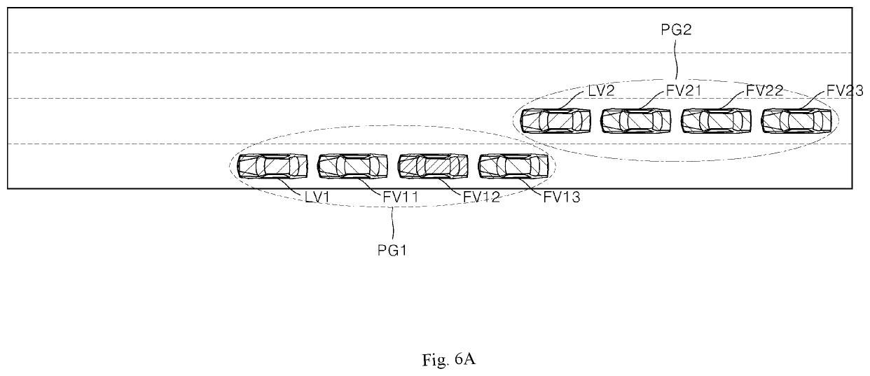

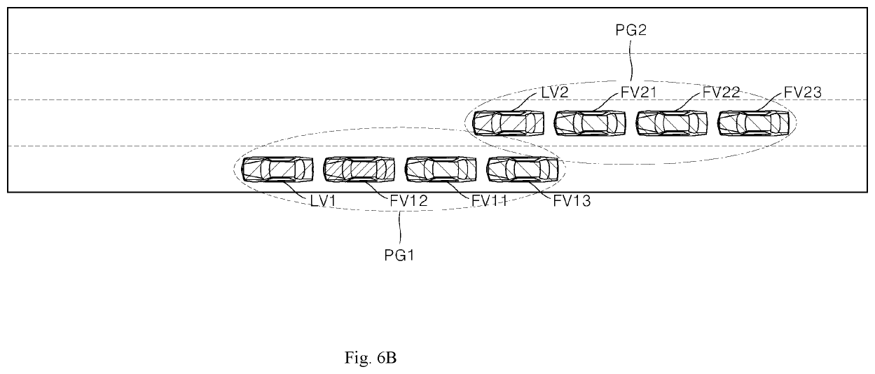

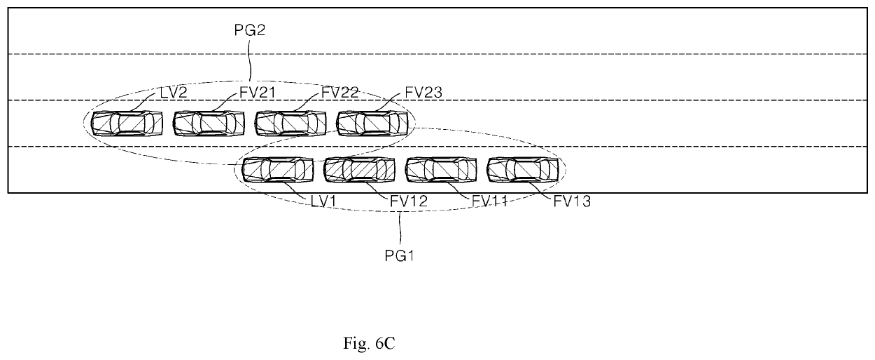

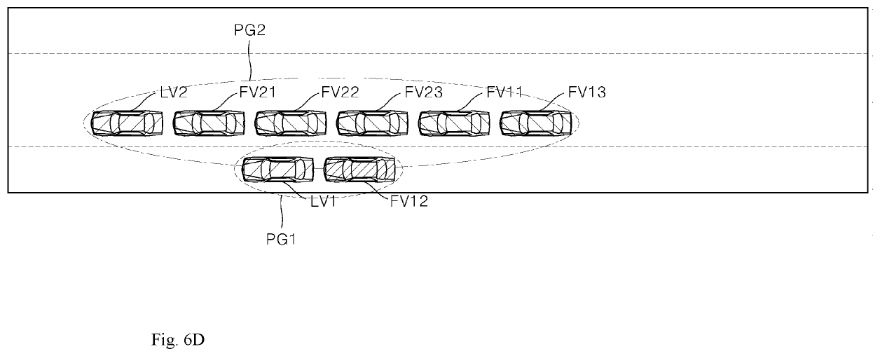

FIGS. 6A to 6D are views illustrating an example in which a vehicle shifts between groups by a vehicle's inter-group shifting method. FIGS. 6A to 6D illustrate an example in which it is advantageous that the first-first following vehicle FV11 and the first-third following vehicle FV13 shift to the second group PG2.

Referring to FIG. 6A, if the distance between the first group PG1 and the second group PG2 falls within a predetermined distance, the first leader vehicle LV1 of the first group PG1 may obtain information about the driving route of the second group PG2 from the second leader vehicle LV2 of the second group PG2. In this case, the first leader vehicle LV1 may previously store information about the driving routes about the following vehicles FV11, FV12, and FV13 of the first group PG1.

The first leader vehicle LV1 may compare the information about the driving route of the second group PG2 with the information about the driving routes of the following vehicles FV11, FV12, and FV13 of the first group PG1 and determine whether the first group PG1 includes a vehicle to which a shift to the second group PG2 is more advantageous.

If it is determined that shifting, to the second group PG2, of the first-first following vehicle FV11 and the first-third following vehicle FV13 is advantageous, the first leader vehicle LV1 may notify the first-first following vehicle FV11 and the first-third following vehicle FV13 that they are scheduled to shift.

In another method, each of the following vehicles FV11, FV12, and FV13 of the first group PG1 may obtain the information about the driving route of the second group PG2 from the second leader vehicle LV2 of the second group PG2.

Each of the following vehicles FV11, FV12, and FV13 of the first group PG1 may compare its own driving route information with the information about the driving route of the second group PG2 and determine which one is more advantageous between staying in the first group PG1 and shifting to the second group PG2.

If shifting, to the second group PG2, of the first-first following vehicle FV11 and the first-third following vehicle FV13 is advantageous, the first-first following vehicle FV11 and the first-third following vehicle FV13 may notify the first leader vehicle LV1 that they are scheduled to shift.

Next, referring to FIG. 6B, the first leader vehicle LV1 may classify the first-first following vehicle FV11 and the first-third following vehicle FV13 into a first temporary group and shift the first temporary group to the tail of the first group PG1. For example, the first leader vehicle LV1 may instruct the vehicles (e.g., the first-first following vehicle FV11 and the first-third following vehicle FV13) of the first temporary group to shift to the tail of the first group PG1, and the vehicles (e.g., the first-first following vehicle FV11 and, according to the instruction, the first-third following vehicle FV13) of the first temporary group may shift to the tail of the first group PG1.

Next, referring to FIG. 6C, the first leader vehicle LV1 may determine whether the time of shift of the vehicles (e.g., the first-first following vehicle FV11 and the first-third following vehicle FV13) of the first temporary group shift has arrived. As shown in FIG. 6C, the first leader vehicle LV1 may determine that the time when the head of the first temporary group (e.g., the first-first following vehicle FV11 and the first-third following vehicle FV13) meets the tail of the second group PG2 is the time of shift of the vehicles of the first temporary group.

Subsequently, referring to FIG. 6D, the vehicles (e.g., the first-first following vehicle FV11 and the first-third following vehicle FV13) of the first temporary group may shift to the second group PG2. For example, the vehicles (e.g., the first-first following vehicle FV11 and the first-third following vehicle FV13) of the first temporary group may shift to the tail of the second group PG2 according to an instruction or particular information from the first leader vehicle LV1. Thus, the first leader vehicle LV1 and the first-second following vehicle FV12 may form the first group G1, and the second leader vehicle LV2, the second-first to second-third following vehicles FV21, FV22, and FV23, the first-first following vehicle FV11, and the first-third following vehicle FV13 may form the second group PG2. The following vehicles in each group may drive after the leader vehicle of the group.

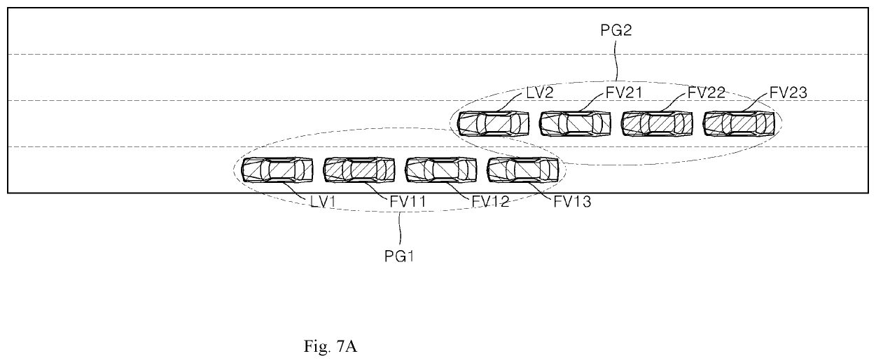

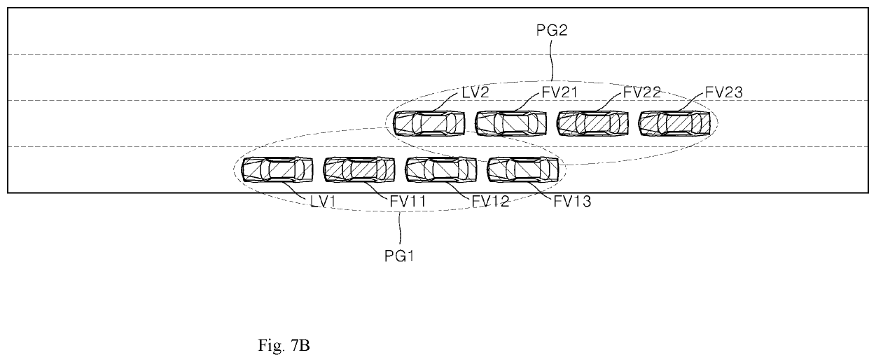

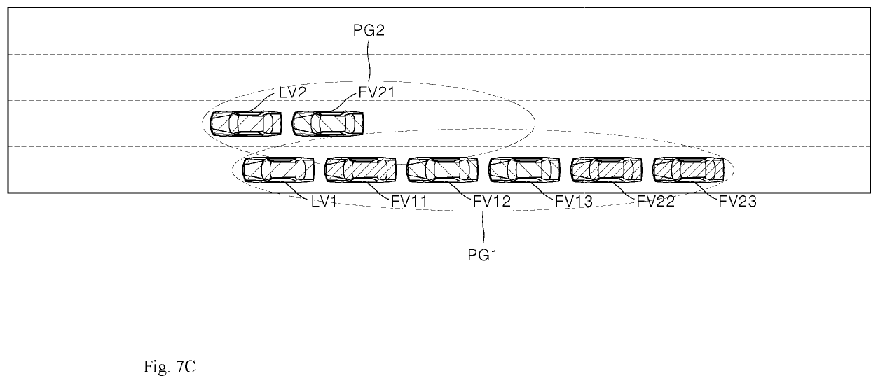

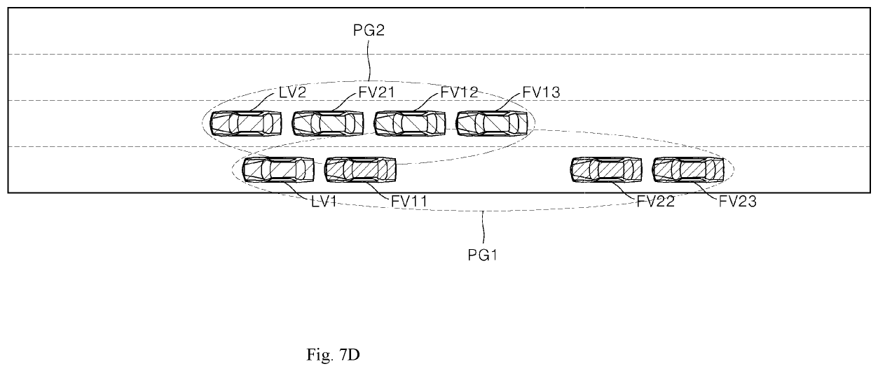

FIGS. 7A to 7D are views illustrating an example in which a vehicle shifts between groups by a vehicle's inter-group shifting method. FIGS. 7A to 7D illustrate an example in which a vehicle shifts from a first group to a second group and vice versa.

Referring to FIG. 7A, if the distance between the first group PG1 and the second group PG2 falls within a predetermined distance, the first leader vehicle LV1 of the first group PG1 may obtain information about the driving route of the second group PG2 from the second leader vehicle LV2 of the second group PG2, and the second leader vehicle LV2 of the second group PG2 may obtain information about the driving route of the first group PG1 from the first leader vehicle LV1 of the first group PG1. In this case, the first leader vehicle LV1 may previously store the information about the driving routes of the following vehicles FV11, FV12, and FV13 of the first group PG1, and the second leader vehicle LV2 may previously store the information about the driving routes of the following vehicles FV21, FV22, and FV23 of the second group PG2.

Each of the first leader vehicle LV1 and the second leader vehicle LV2 may determine whether its group includes a vehicle to which a shift to the other group is more advantageous.

If it is determined that shifting, to the second group PG2, of the first-second following vehicle FV12 and the first-third following vehicle FV13 is advantageous, the first leader vehicle LV1 may notify the first-second following vehicle FV12 and the first-third following vehicle FV13 that they are scheduled to shift. If it is determined that shifting, to the first group PG1, of the second-second following vehicle FV22 and the second-third following vehicle FV23 is advantageous, the second leader vehicle LV2 may notify the second-second following vehicle FV22 and the second-third following vehicle FV23 that they are scheduled to shift.

In another method, each of the following vehicles FV11, FV12, and FV13 of the first group PG1 and the following vehicles FV21, FV22, and FV23 of the second group PG2 may obtain information about the driving route of the other group from the leader vehicle LV1 or LV2 of the other group and determine which one is more advantageous between staying in the current group and shifting to the other group.

Where it is determined that shifting, to the second group PG2, of the first-second following vehicle FV12 and the first-third following vehicle FV13 is advantageous and that shifting, to the first group PG1, of the second-second following vehicle FV22 and the second-third following vehicle FV23 is advantageous, the first-second following vehicle FV12 and the first-third following vehicle FV13 may notify the first leader vehicle LV1 that they are scheduled to shift, and the second-second following vehicle FV22 and the second-third following vehicle FV23 may notify the second leader vehicle LV2 that they are scheduled to shift.

Next, referring to FIG. 7B, the first leader vehicle LV1 may determine that the time of shift of the vehicles (e.g., the first-first following vehicle FV11 and the first-third following vehicle FV13) of the first temporary group has arrived, and the second leader vehicle LV2 may determine that the time of shift of the vehicles (e.g., the second-second following vehicle FV22 and the second-third following vehicle FV23) of the second temporary group has arrived. As shown in FIG. 7B, the second leader vehicle LV2 may determine that the time when the head of the second temporary group (e.g., the second-second following vehicle FV22 and the second-third following vehicle FV23) meets the tail of the first group PG1 is the time of shift of the vehicles of the second temporary group.

Next, referring to FIG. 7C, the vehicles (e.g., the second-second following vehicle FV22 and the second-third following vehicle FV23) of the second temporary group may shift to the tail of the first group PG1. Thereafter, the first leader vehicle LV1 may determine whether the time of shift of the vehicles (e.g., the first-first following vehicle FV11 and the first-third following vehicle FV13) of the first temporary group has arrived. As shown in FIG. 7C, the first leader vehicle LV1 may determine that the time when the head of the first temporary group (e.g., the first-first following vehicle FV11 and the first-third following vehicle FV13) meets the tail of the second group PG2 is the time of shift of the vehicles of the first temporary group.

Then, referring to FIG. 7D, the vehicles (e.g., the first-second following vehicle FV12 and the first-third following vehicle FV13) of the first temporary group shift to the second group PG2. Thus, the first leader vehicle LV1, the first-first following vehicle FV11, the second-second following vehicle FV22, and the second-third following vehicle FV23 may form the first group PG1, and the second leader vehicle LV2, the second-first following vehicle FV21, the first-second following vehicle FV12, and the first-third following vehicle FV13 may form the second group PG2.

The interval between the first-first following vehicle FV11 and the second-second following vehicle FV22 may then be narrowed.

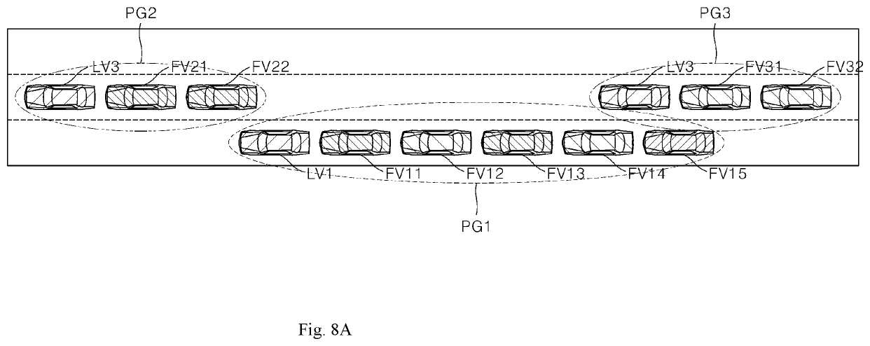

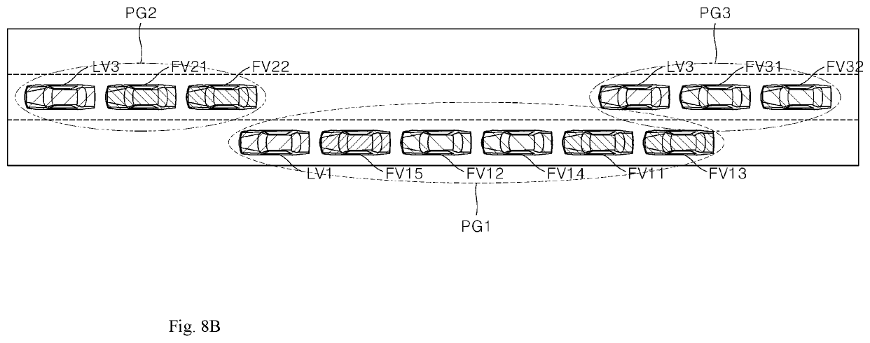

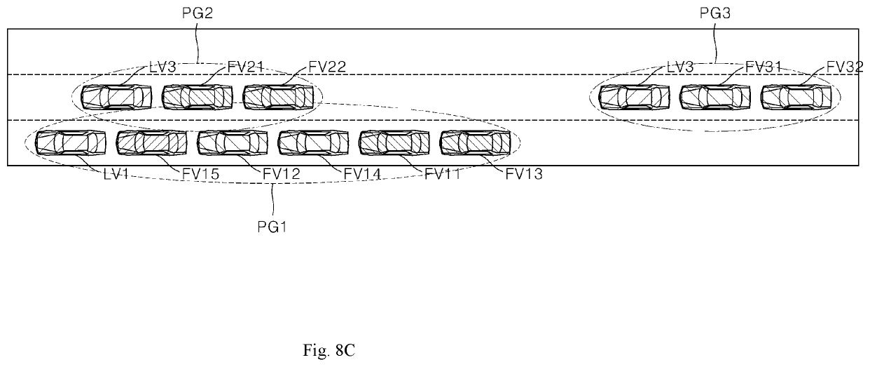

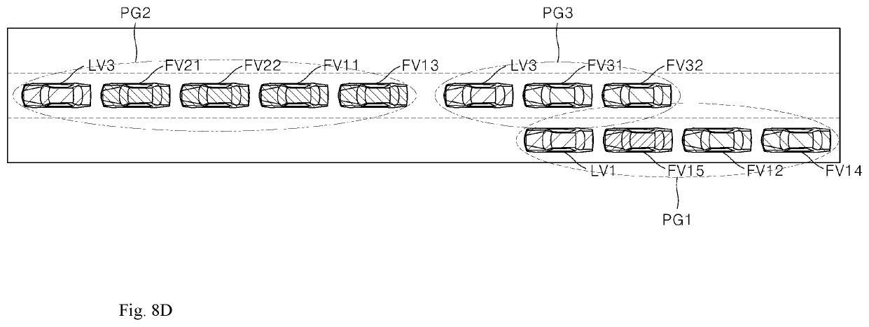

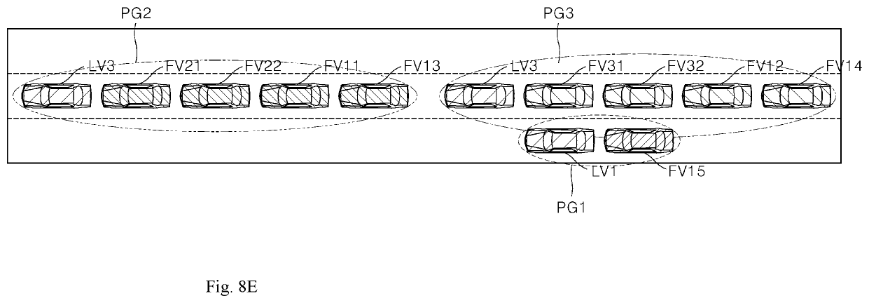

FIGS. 8A to 8E are views illustrating an example in which a vehicle shifts between groups by a vehicle's inter-group shifting method. FIGS. 8A to 8E illustrate an example in which vehicles shift from one group to other multiple groups. FIGS. 8A to 8E illustrate the hypothesis that a shift to the second group PG2 is advantageous to the first-first following vehicle FV11 and the first-third following vehicle FV13, a shift to the third group PG3 is advantageous to the first-second following vehicle FV12 and the first-fourth following vehicle FV14, and staying in the first group PG1 is advantageous to the first-fifth following vehicle FV15.

Referring to FIG. 8A, if the distance between the first group PG1 and the second group PG2 and the distance between the first group PG1 and the third group PG3 fall within a predetermined distance, the first leader vehicle LV1 of the first group PG1 may obtain information about the driving route of the second group PG2 from the second leader vehicle LV2 of the second group PG2 and information about the driving route of the third group PG3 from the third leader vehicle LV3 of the third group PG3. In this case, the first leader vehicle LV1 may previously store information about the driving routes about the following vehicles FV11, FV12, FV13, FV14, and FV15 of the first group PG1.

The first leader vehicle LV1 may compare the information about the driving route of the second group PG2 and the information about the driving route of the third group PG3 with the information about the driving routes of the following vehicles FV11, FV12, FV13, FV14, and FV15 of the first group PG1 and determine whether the first group PG1 includes a vehicle to which a shift to the second group PG2 or the third group PG3 is more advantageous.

Where it is determined that shifting, to the second group PG2, of the first-first following vehicle FV12 and the first-third following vehicle FV13 is advantageous and that shifting, to the third group PG3, of the first-second following vehicle FV12 and the first-fourth following vehicle FV14 is advantageous, the first leader vehicle LV1 may notify the first-first following vehicle FV11, the first-second following vehicle FV12, the first-third following vehicle FV13, and the first-fifth following vehicle FV15 that they are scheduled to shift.

In another method, each of the following vehicles FV11, FV12, FV13, FV14, and FV15 of the first group PG1 may obtain the information about the driving route of the second group PG2 from the second leader vehicle LV2 of the second group PG2 and obtain the information about the driving route of the third group PG3 from the third leader vehicle LV3 of the third group PG3.

Each of the following vehicles FV11, FV12, FV13, FV14, and FV15 of the first group PG1 may compare its own driving route information with the information about the driving route of the second group PG2 and the information about the driving route of the third group PG3 and determine which one is more advantageous between staying in the first group PG1 and shifting to the second group PG2 or the third group PG3.

Where shifting, to the second group PG2, of the first-first following vehicle FV12 and the first-third following vehicle FV13 is advantageous, and shifting, to the third group PG3, of the first-second following vehicle FV12 and the first-fourth following vehicle FV14 is advantageous, the first-first following vehicle FV11, the first-second following vehicle FV12, the first-third following vehicle FV13, and the first-fourth following vehicle FV14 may notify the first leader vehicle LV1 that they are scheduled to shift.

Next, referring to FIG. 8B, the vehicles of the first group PG1 may prepare for an inter-group shift. Specifically, the first leader vehicle LV1 may designate the locations of the temporary groups considering the times of shift of the first temporary group (e.g., the first-first following vehicle FV11 and the first-third following vehicle FV13) and the second temporary group (e.g., the first-second following vehicle FV12 and the first-fourth following vehicle FV14). In other words, where the first temporary group shifts earlier than the second temporary group, the first leader vehicle LV1 may shift the first temporary group (e.g., the first-first following vehicle FV11 and the first-third following vehicle FV13) to the tail of the first group PG1 and the second temporary group (e.g., the first-second following vehicle FV12 and the first-fourth following vehicle FV14) ahead of the first temporary group as shown in FIG. 8B.

Next, referring to FIG. 8C, the first leader vehicle LV1 may determine whether the time of shift of the vehicles (e.g., the first-first following vehicle FV11 and the first-third following vehicle FV13) of the first temporary group shift has arrived. As shown in FIG. 8C, the first leader vehicle LV1 may determine that the time when the head of the first temporary group (e.g., the first-first following vehicle FV11 and the first-third following vehicle FV13) meets the tail of the second group PG2 is the time of shift of the vehicles of the first temporary group.

Subsequently, referring to FIG. 8D, the vehicles (e.g., the first-first following vehicle FV11 and the first-third following vehicle FV13) of the first temporary group may shift to the second group PG2. For example, the vehicles (e.g., the first-first following vehicle FV11 and the first-third following vehicle FV13) of the first temporary group may shift to the tail of the second group PG2 according to an instruction or particular information from the first leader vehicle LV1.

Further, the first leader vehicle LV1 may determine whether the time of shift of the vehicles (e.g., the first-second following vehicle FV12 and the first-fourth following vehicle FV14) of the second temporary group has arrived. As shown in FIG. 8D, the first leader vehicle LV1 may determine that the time when the head of the second temporary group (e.g., the first-second following vehicle FV12 and the first-fourth following vehicle FV14) meets the tail of the third group PG3 is the time of shift of the vehicles of the second temporary group.

Subsequently, referring to FIG. 8E, the vehicles (e.g., the first-second following vehicle FV12 and the first-fourth following vehicle FV14) of the second temporary group may shift to the third group PG3. For example, the vehicles (e.g., the first-second following vehicle FV12 and the first-fourth following vehicle FV14) of the second temporary group may shift to the tail of the third group PG3 according to an instruction or particular information from the first leader vehicle LV1.

Thus, the first leader vehicle LV1 and the first-fifth following vehicle FV15 may form the first group PG1, the second leader vehicle LV2, the second-first following vehicle FV21, the second-second following vehicle FV22, the first-first following vehicle FV11, and the first-third following vehicle FV13 may form the second group PG2, and the third leader vehicle LV3, the third-first following vehicle FV31, the third-second following vehicle FV32, the first-second following vehicle FV12, and the first-fourth following vehicle FV14 may form the third group PG3. The following vehicles in each group may drive after the leader vehicle of the group.

Although in the above example described the leader vehicle in the group determines the time when a following vehicle shifts groups, the above-described process may also be performed primarily by the following vehicles. For example, a following vehicle in the first temporary group which shifts from the first group to the second group may determine that the time when the tail of the second group meets the head of the first temporary group is the time of inter-group shift and may shift from the first group to the second group at the time of inter-group shift. In this case, the following vehicle shifting from the first group to the second group may transmit a message for indicating that the first vehicle is to shift to the leader vehicle of the first group.

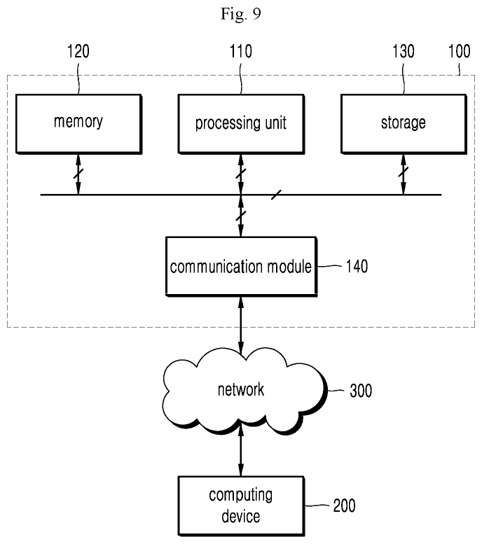

FIG. 9 is a block diagram schematically illustrating a computing device capable of implementing a vehicle's inter-group shifting method. A computing device 100 may include a processing unit 110, a memory 120, storage 130, and a communication module 140. The computing device shown in FIG. 9 may be included in a vehicle (e.g., a leader vehicle or a following vehicle).

The processing unit 110 may include, e.g., a central processing unit (CPU), a graphic processing unit (GPU), a microprocessor, an application specific integrated circuit (ASIC), or field programmable gate arrays (FPGA). The processing unit may have a plurality of cores.

The memory 120 may be a volatile memory (e.g., a random access memory (RAM), a non-volatile memory (e.g., a read-only memory (ROM) or flash memory), or a combination thereof.

The storage 130 includes, but is not limited to, magnetic storage or optical storage. The storage 130 may store computer-readable commands for implementing a vehicle's inter-group shifting method and may further store other computer-readable commands for implementing an operating system (OS) or application programs. The computer-readable commands (or instructions) stored in the storage 130 may be loaded onto the memory 120 to be executed by the processing unit 110.

The communication module 140 enables a computing device 100 in any one vehicle to communicate with a computing device 200 in another vehicle. The communication module 140 may include a radio frequency transceiver according to various standards. The communication module 140 may connect to a network (e.g., a controller area network (CAN) in the vehicle.

The processing unit 110, the memory 120, the storage 130, and the communication module 140 may be connected by various mutual connections, e.g., bus, and all or some thereof may be implemented in a single chip.

The computing device 100 in any one vehicle may communicate with a computing device 200 in another vehicle via the network 300. In this case, the network 300 may be a 5G network or network for vehicle-to-everything (V2X) communication. However, the concept of the disclosure is not limited to any particular type or feature of network 300.

What is claimed is:

1. A method of shifting a vehicle between groups, the method comprising:
obtaining, by at least one vehicle of a first group of vehicles that is platooning, driving route information about a second group of vehicles that is platooning;
determining, by at least one vehicle of the first group of vehicles, whether at least one first vehicle of the first group of vehicles shifts from the first group of vehicles to the second group of vehicles; and
shifting, by at least one vehicle of the first group of vehicles, a first temporary group of vehicles including the at least one first vehicle of the first group of vehicles to the second group of vehicles.

2. The method of claim 1, wherein:
the first group of vehicles includes a first leader vehicle driving at the head of the first group of vehicles and at least one first following vehicles following the first leader vehicle,
the second group includes a second leader vehicle driving at the head of the second group and storing driving route information about the second group of vehicles, and at least one second following vehicles following the second leader vehicle, and
the method comprises:
storing, by the first leader vehicle, driving route information about the at least one first following vehicles and driving route information about the first group of vehicles.

3. The method of claim 2, wherein obtaining the driving route information about the second group of vehicles comprises:
obtaining, by the first leader vehicle, the driving route information about the second group of vehicles from the second leader vehicle.

4. The method of claim 2, wherein determining whether the at least one first vehicle of the first group of vehicles shifts from the first group of vehicles to the second group of vehicles comprises:
comparing, by the first leader vehicle, the driving route information about the at least one first following vehicles with the driving route information about the second group of vehicles; and
determining, by the first leader vehicle, that a vehicle, among the at least one first following vehicles, to shift to the second group of vehicles is of the first temporary group of vehicles.

5. The method of claim 4, wherein determining that the vehicle to shift to the second group of vehicles is of the first temporary group of vehicles comprises:
notifying, by the first leader vehicle, the first temporary group of vehicles that the vehicle is scheduled to shift.

6. The method of claim 2, wherein obtaining the driving route about the second group of vehicles comprises:
obtaining, by each of the at least one first following vehicles, the driving route information about the second group of vehicles from the second leader vehicle.

7. The method of claim 6, wherein:
determining whether the at least one first vehicle of the first group of vehicles shifts from the first group of vehicles to the second group of vehicles comprises:
comparing, by each of the at least one first following vehicles, the driving route information about the first following vehicle with the driving route information about the second group of vehicles; and
notifying, by each of the at least one first following vehicles, the first leader vehicle that a vehicle is scheduled to shift based on comparing the driving route information about the first following vehicle with the driving route information about the second group of vehicles, and
the first leader vehicle sets the vehicle scheduled to shift to be of the first temporary group of vehicles.

8. The method of claim 1, further comprising shifting the first temporary group of vehicles to a tail of the first group of vehicles.

9. The method of claim 1, wherein shifting the first temporary group of vehicles including the at least one first vehicle of the first group of vehicles to the second group of vehicles comprises:
shifting the first temporary group of vehicles from the first group of vehicles to the second group of vehicles based on a tail of the second group of vehicles meets a head of the first temporary group of vehicles.

10. The method of claim 1, comprising:
obtaining driving route information about a third group of vehicles that is platooning;
determining whether at least one other vehicle of the first group of vehicles, except for the first temporary group of vehicles, shifts from the first group of vehicles to the third group of vehicles; and
shifting a second temporary group of vehicles including at least one other vehicle of the first group of vehicles from the first group of vehicles to the third group of vehicles.

11. The method of claim 10, comprising:
determining an order in which the first temporary group of vehicles and the second temporary group shift of vehicles; and
allowing (i) a temporary group of vehicles to shift earlier between the first temporary group of vehicles, (ii) the second temporary group of vehicles to shift to a tail of the first group of vehicles, and (iii) another temporary group of vehicles to shift ahead of the temporary group of vehicles.

12. The method of claim 2, comprising:
determining, by the first leader vehicle, a time of shift of the first temporary group of vehicles based on one or more of:
a distance between the first group of vehicles and the second group of vehicles,
a location of the first group of vehicles,
a location of the second group of vehicles,
a speed of the first group of vehicles, and
a speed of the second group of vehicles.

13. The method of claim 2, comprising:
obtaining, by the second leader vehicle or the at least one second following vehicles, the driving route information about the first group of vehicles from the first leader vehicle;
determining whether at least one of the at least one second following vehicles shifts from the second group of vehicles to the first group of vehicles; and
shifting a second temporary group of vehicles including at least one of the at least one second following vehicle from the second group of vehicles to the first group of vehicles.

14. A method of shifting a vehicle between groups, the method comprising:
obtaining, by a first leader vehicle driving at a head of a first group of vehicles that is platooning, information about a driving route of a second group of vehicles from a second leader vehicle driving at a head of the second group of vehicles that is platooning;
comparing, by the first leader vehicle, the information about the driving route of the second group of vehicles with information about a driving route of at least one first following vehicles driving behind the first leader vehicle;
determining, by the first leader vehicle, that a following vehicle, among the at least one first following vehicles, to shift to the second group of vehicles is of a first temporary group of vehicles; and
transmitting, by the first leader vehicle and to a vehicle included in the first temporary group of vehicles, a message allowing the first temporary group of vehicles to shift from the first group of vehicles to the second group of vehicles.

15. The method of claim 14, wherein determining that the following vehicle to shift to the second group of vehicles is of a first temporary group of vehicles comprises:
determining that a platooning maintaining time of the following vehicle or a platooning maintaining distance of the following vehicle is longer when shifting to the second group of vehicles than when staying in the first group of vehicles.

16. The method of claim 14, comprising:
transmitting, by the first leader vehicle to a vehicle included in the first temporary group, a message allowing the first temporary group of vehicles to shift to a tail of the first group of vehicles.

17. The method of claim 14, comprising:
obtaining, by the first leader vehicle, information about a driving route of a third group of vehicles from a third leader vehicle driving at a head of the third group of vehicles that is platooning;
comparing, by the first leader vehicle, the information about the driving route of the third group with information about a driving route of at least one first following vehicles driving behind the first leader vehicle;
determining, by the first leader vehicle, that a following vehicle, among the at least one first following vehicles, to shift to the third group of vehicles is of a second temporary group; and
transmitting, by the first leader vehicle to a vehicle included in the second temporary group of vehicles, a message allowing the second temporary group of vehicles to shift from the first group of vehicles to the third group of vehicles.

18. The method of claim 17, further comprising:
determining, by the first leader vehicle, an order in which the first temporary group of vehicles and the second temporary group of vehicles shift; and
transmitting, by the first leader vehicle and to a vehicle included in the first temporary group of vehicles and a vehicle included in the second temporary group of vehicles, a message allowing (i) a temporary group to shift earlier to the first temporary group, (ii) the second temporary group to shift to the tail of the first group, and (iii) another temporary group to shift ahead of the temporary group.

19. A method of shifting a vehicle between groups, the method comprising:
obtaining, by a first following vehicle following a first leader vehicle driving at a head of a first group of vehicles that is platooning, information about a driving route of a second group of vehicles from a second leader vehicle driving at a head of the second group of vehicles that is platooning;
comparing, by the first following vehicle, the information about the driving route of the second group of vehicles with information about a driving route of the first following vehicle;
based on comparing the information about the driving route of the second group of vehicles with information about the driving route of the first following vehicle, determining, by the first following vehicle, whether to shift to the second group of vehicles;
transmitting, by the first following vehicle and to the first leader vehicle, a message indicating that the first following vehicle is scheduled to shift to the second group of vehicles; and
shifting the first following vehicle from the first group of vehicles to the second group of vehicles.

20. The method of claim 19, comprising:
relocating the first following vehicle in the first group of vehicles in response to the message received by the first leader vehicle.
